(19) United States
(12) Patent Application Publication
(10) Pub. No.: US 2006/0029868 A1
(43) Pub. Date: Feb. 9, 2006

(54) Method and device for manufacturing a color filter

(75) Inventor: Hsin Wei Huang, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/173,716

(22) Filed: Jun. 30, 2005

(30) Foreign Application Priority Data
Aug. 6, 2004 (TW) 93123611

(51) Int. Cl. G02B 5/20; G02F 1/1335

(52) U.S. Cl. 430/7; 355/67

(57) ABSTRACT

A method and device for manufacturing a color filter. The method includes: providing a substrate (30), forming a black matrix (31) on the substrate, forming a color photo-resist layer (32) on the substrate including the black matrix, photolithographing the color photo-resist layer, partly photolithographing the color photo-resist layer corresponding to each edge of opening of the black matrix, and forming a transparent conductive layer (34). The device includes an exposure unit, the exposure unit including a mask for exposing the color photo-resist layer, the mask including a light-shielding area and a light transmitting area, there is a slit in each edge of the light-shielding area. The color filter employing the method and device can avoid protrusions. The process for manufacturing the color filter is simplified, and costs are reduced. Additionally, a thickness of the color filter can be reduced, which can increase a light transmittance of the color filter.

### FIELD OF THE INVENTION

The present invention relates to a method and a device for manufacturing a color filter.

### BACKGROUND

Because a liquid crystal display (LCD) device has the merits of being thin, light in weight, and drivable by a low voltage, it is extensively employed in various electronic devices. A typical LCD device includes a LCD panel. The LCD panel includes two transparent substrates parallel to each other, and a liquid crystal layer disposed between the two substrates. In order to make the liquid crystal display device display a full-colored image, a color filter is usually employed in the device. A typical color filter provides three primary colors: red, green, and blue. The color filter, the liquid crystal layer and a switching element arranged on the substrate cooperate to make the liquid crystal display device display full-colored images.

Referring to FIG. 5, a typical color filter 1 includes a glass substrate 10, a black matrix 11 disposed on the glass substrate 10, and a color photo-resist layer 12 disposed among the black matrix 11. A transparent overcoat layer 13 and a transparent conductive layer 14 are arranged on the black matrix 11 and color photo-resist layer 12, in that sequence. The glass substrate 10 acts as a carrier of the above-mentioned elements. The color photo-resist layer 12 consists of three primary colors: red, green, and blue. The color photo-resist layer 12 includes a plurality of color groups, and each color group includes three primary color portions: a red portion, a green portion, and blue portion, all arranged in a predetermined pattern. The black matrix 11 is disposed among the primary color portions.

When white light reaches the black matrix 11 and color photo-resist layer 12, the red portion allows red rays to pass therethrough, and blocks other rays from passing therethrough. The green portion allows green rays to pass therethrough, and blocks other rays from passing therethrough. The blue portion allows blue rays to pass therethrough, and blocks other rays from passing therethrough. Thus only three colored rays, namely red, green and blue rays, pass through the color photo-resist layer 12.

The black matrix 11 is used to close off light beams from spreading among the primary color portions; that is, to prevent light beams from mixing among the different primary color portions. The transparent overcoat layer 13 is used to planarize the color filter 1. The transparent conductive layer 14 is used to cooperate with a matrix of thin film transistors (not shown) to control quantities of colored rays passing through the color photo-resist layer 12, and thereby to obtain different colors for a displayed image.

In general, the color filter 1 is manufactured according to the following steps:
forming the black matrix 11 on the glass substrate 10, the black matrix 11 being discontinuously distributed thereon;
forming the color photo-resist layer 12 on the glass substrate 10 including the black matrix 11;
forming the transparent overcoat layer 13 on the glass substrate 10 including the black matrix 11 and the color photo-resist layer 12; and
forming the transparent conductive layer 14, thereby obtaining the color filter 1.

In order to obtain a color filter 1 with fine optical characteristics, the color photo-resist layer 12 is usually formed so that it partly overlaps the black matrix 11. After photolithographing and developing the color photo-resist layer 12, in general, parts of the color photo-resist layer 12 that overlap the black matrix 11 form protrusions 120, as shown in FIG. 6. The protrusions 120 cause the color photo-resist layer 12 to have a rough surface.

To resolve this problem, the transparent overcoat layer 13 is formed on the color photo-resist layer 12. The transparent overcoat layer 13 smoothes out the surface of the color photo-resist layer 12. Thereafter, the transparent conductive layer 14 is formed on the transparent overcoat layer 13.

The need for the step of forming the transparent overcoat layer 13 on the color photo-resist layer 12 increases costs. In addition, the color filter 1 has an increased thickness, and therefore a decreased light transmittance.

Therefore, a new method and device for manufacturing a color filter that can overcome the above-described problems are desired.

### SUMMARY

In one embodiment, a method for manufacturing a color filter includes the steps of providing a substrate, forming a black matrix on the substrate, forming a color photo-resist layer on the substrate including the black matrix, photolithographing the color photo-resist layer, partly photolithographing the color photo-resist layer corresponding to each edge of opening of the black matrix.

In another embodiment, a device for manufacturing a color filter includes an exposure unit, the exposure unit includes a mask for exposing the color photo-resist layer, the mask includes a light-shielding area and a light transmitting area, there is a slit in each edge of the light-shielding area.

The method and device for manufacturing a color filter provided herein have the following advantages. In one embodiment of the invention, a method for manufacturing a color filter includes the step of photolithographing the color photo-resist layer, at the same time, a step of partly photolithographing the color photo-resist layer corresponding to each edge of opening of the black matrix is performed. Thus the color filter employing the method can avoid protrusions. Consequently, the additional transparent overcoat layer for planarizing the top surface of the color photo-resist layer is unnecessary, although still optional. When no overcoat layer is needed, the process for manufacturing the color filter is simplified, and costs are reduced. Additionally, when the overcoat layer is omitted, a thickness of the color filter is reduced. This can increase a light transmittance of the color filter. In another embodiment of the invention, a device for manufacturing a color filter is provided, the device is used in the method for manufacturing a color filter and has similar advantages as performing the method.

Other advantages and novel features of the embodiments will become more apparent from the following detailed description when taken in conjunction with the accompanying drawings; in which:

### BRIEF DESCRIPTION OF THE DRAWINGS

FIG. 1 is a schematic, cross-sectional view of part of a color filter according to an exemplary embodiment of the present invention;

FIG. 2 is a flowchart of a method for manufacturing the color filter of FIG. 1;

FIG. 3 is a schematic, top plan view of a mask used in the method of FIG. 2;

FIG. 4 is an enlarged, schematic, side cross-sectional view of part of an uncoated color filter obtained in the process of performing the method of FIG. 2, the uncoated color filter not having any substantial protrusions;

FIG. 5 is a schematic, cross-sectional view of part of a typical color filter, showing incoming and outgoing light paths thereof; and

FIG. 6 is an enlarged, schematic, side cross-sectional view of part of an uncoated color filter obtained in the process of performing a typical method for manufacturing a color filter, the uncoated color filter having protrusions.

### DETAILED DESCRIPTION OF PREFERRED EMBODIMENTS

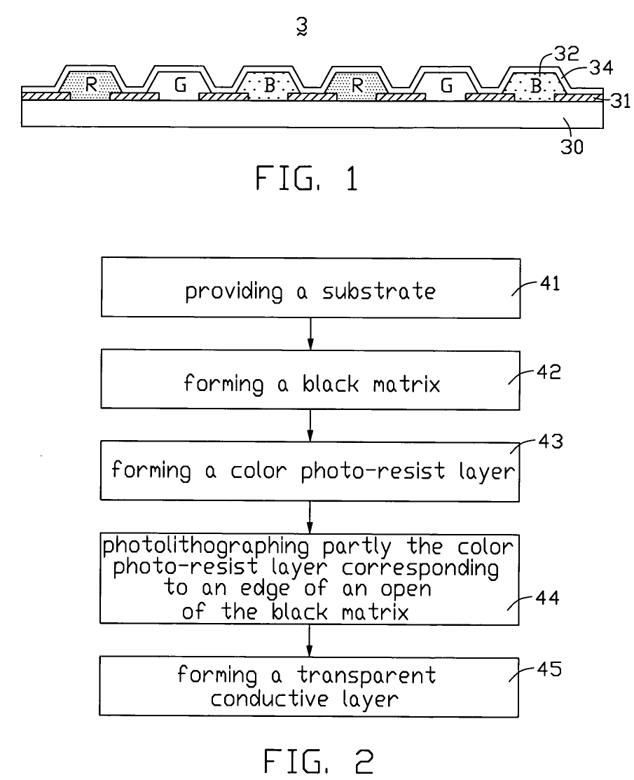

Referring to FIG. 1, an exemplary color filter 3 includes a substrate 30, a black matrix 31 disposed on the substrate 30, and a color photo-resist layer 32 disposed among the black matrix 31. A transparent conductive layer 34 is arranged on the black matrix 31 and the color photo-resist layer 32. The substrate 30 acts as a carrier of the above-described elements. The color photo-resist layer 32 includes three primary colors: red, green, and blue. The color photo-resist layer 32 includes a plurality of color groups, and each color group includes three primary color portions: a red portion, a green portion, and blue portion, all of which are arranged in a predetermined pattern. The black matrix 11 is disposed among the primary color portions.

FIG. 2 is a flowchart of a method for manufacturing the color filter 3. The method includes the following steps:
step 41: providing the substrate 30;
step 42: forming the black matrix 31 on the substrate 30, the black matrix 31 being discontinuously distributed thereon;
step 43: forming the color photo-resist layer 32 on the substrate 30 including the black matrix 31;
step 44: photolithographing the color photo-resist layer 32, partly photolithographing the color photo-resist layer 32 corresponding to the edges of opening of the black matrix 31;
step 45: forming the transparent conductive layer 34.

In step 41, the substrate 30 acts as a carrier, and usually is made from a fiolax. Of course, the substrate 30 also may be made from glass with a relatively low concentration of alkali ions.

In step 42, the substrate 30 is washed. A black resin layer with a uniform thickness is coated on the substrate 30 using a spin coater. Then the black resin layer is dried under a low pressure so that some solvent is removed. After that, the black resin layer is soft-baked. This removes residual solvent, adds to an adhesive strength of the black resin layer, and decreases an internal stress of the black resin layer.

Then, the black resin layer is photolithographed and developed using a mask and ultraviolet radiation. Chemical properties of the black resin layer change after the irradiation by the ultraviolet rays. The substrate 30 having the black resin layer is washed with a developing solution. Irradiated portions of the black resin layer are far more soluble than unexposed portions of the black resin layer. Thus the irradiated portions of the black resin layer dissolve and are removed, thereby obtaining the black matrix 31. Then the substrate 30 is hard-baked to remove residual developing solution. This step also improves an anti-etching characteristic of the black matrix 31, increases an adhesive strength of the black matrix 31, and increases a flatness of the black matrix 31.

In step 43, the color photo-resist layer 32 is formed by distributing dyes. In general, the color photo-resist layer 32 is derived from a solution for thinning the dyes, a PMMA (Polymethyl Methacrylate) resin, and a photosensitive material. The photosensitive material is a negative photoresist material, and forms a cross linked structure after being irradiated. The cross linked structure can protect a weakly alkaline solution from being eroded, and can help fix the color photo-resist layer 32 on the substrate 30 and black matrix 31.

A photoresist layer (not shown) is coated on the substrate 30, and the photoresist layer is pre-baked to improve its stability.

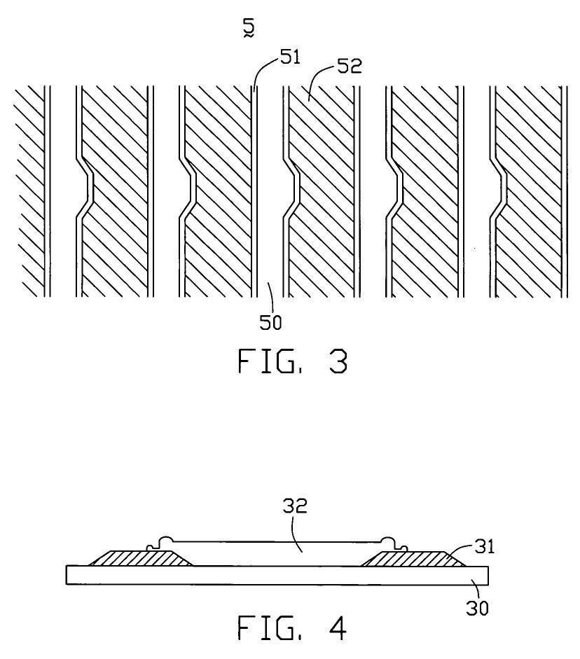

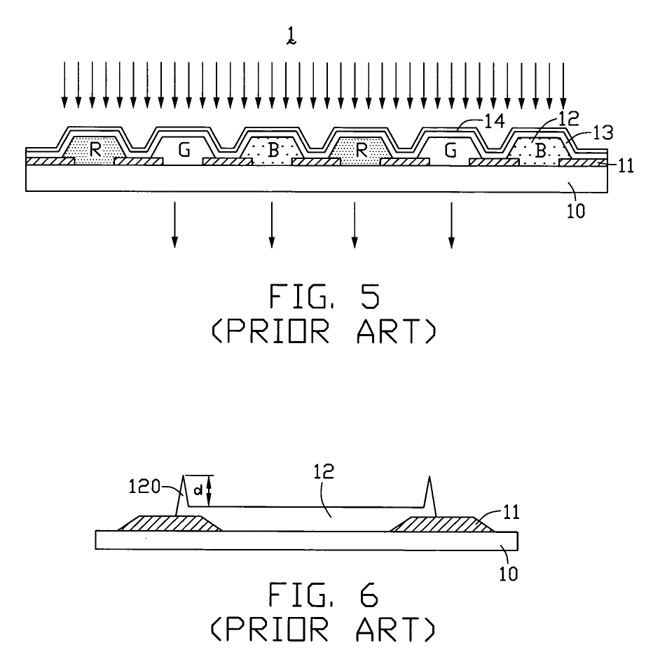

In step 44, referring to FIG. 3, the photoresist layer is photolithographed using a mask 5. The mask 5 includes a plurality of light transmitting areas 50 corresponding to openings among the black matrix 31, and a plurality of light-shielding areas 52 located among the light transmitting areas 50. Each light transmitting area 50 has at least two edges adjacent to the corresponding light-shielding areas 52. One or more slits 51 are defined in each edge, with each slit 51 having a width in the range from 0.1 μm to 51 μm.

After photolithographing and developing the photoresist layer and color photo-resist layer 32 by employing the mask 5, the substrate 30 with the color photo-resist layer 32 thereon is obtained, as shown in FIG. 4. As shown in FIG. 6, parts of the photoresist layer corresponding to the slits 51 cannot be exposed substantially and cannot harden completely. That is, only parts of photoresist layer corresponding to the slits 51 can be removed. Thus parts of the color photo-resist layer 32 that completely overlap the black matrix 31 can be substantially or even completely removed. No undesired protrusions are created, or any protrusions created are not substantial. The substrate 30 having the black matrix 31 and color photo-resist layer 32 thereon can have a substantially smooth top surface, and helps produce a finer image quality. Additionally, when the substrate 30 having the black matrix 31 and color photo-resist layer 32 thereon has a smooth top surface, no transparent overcoat layer is needed.

To obtain a colorful filter, step 43 and step 44 usually need to be repeated three times, thus a red photo resist layer, a green photo resist layer and a blue photo resist layer can be formed and photolithographed, thus finally a colorful layer disposed among opening of the black matrix 31 can be obtained, wherein the colorful layer includes three colors portions: red, green and blue portions arranged in a certain order.

In step 45, the transparent conductive layer 34 generally includes one or both of Indium Tin Oxide (ITO) and Indium Zinc Oxide (IZO). The transparent conductive layer 34 is usually formed on the substrate 30 by a sputter method. An electric field is created in a vacuum cavity filled with argon gas, such that arc discharge of the argon gas is produced. Argon ions (Ar⁺) with kinetic energy bombard a surface of (say) an ITO target on a cathode. ITO atoms are sputtered onto a surface of the substrate 30 and progressively accumulate to form a film. Additionally, a magnetic field is created, to change a direction of movement of the argon ions. In the magnetic field, magnetic lines of force are parallel to the surface of the ITO target. This increases several-fold the quantity of argon ions bombarding the ITO target. Thus an ITO film can be sputtered onto the substrate 30 at a low temperature even if a pressure of the argon gas is low.

The color filter 3 is thus obtained. The above-described method for manufacturing the color filter 3 can avoid the creation of protrusions. Consequently, the additional transparent overcoat layer 34 for planarizing the top surface of the color photo-resist layer 32 is unnecessary, although still optional. When no overcoat layer 34 is needed, the process for manufacturing the color filter is simplified, and costs are reduced. Additionally, when the overcoat layer is omitted, a thickness of the color filter is reduced. This can increase a light transmittance of the color filter.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A method for manufacturing a color filter, comprising the steps of:
providing a substrate;
forming a black matrix on the substrate;
forming a color photo-resist layer on the substrate; and
photolithographing the color photo-resist layer, partly photolithographing the color photo-resist layer corresponding to each edge of opening of the black matrix.

2. The method according to claim 1, wherein the color photo-resist layer is formed by distributing dyes.

3. The method according to claim 1, wherein the transparent productive layer is formed by sputter.

4. The method according to claim 1, wherein photolithograph is performed with ultraviolet rays.

5. The method according to claim 1, further comprising the step of forming a transparent conductive layer on the color photo-resist layer and black matrix.

6. A device for manufacturing a color filter comprising an exposure unit, the exposure unit comprising a mask for exposing a color photo-resist layer formed on a substrate, the mask comprising a plurality of light-shielding areas and a plurality of light transmitting areas, wherein each edge of each light-shielding area defines a slit.

7. The device according to claim 6, wherein the slit has a width in the range from 0.1 μm to 5 μm.

8. A method for manufacturing a color filter, comprising the steps of:
providing a substrate;
forming a black matrix on the substrate;
forming a color photo-resist layer on the substrate; and
photolithographing the color photo-resist layer by using a mask with slits therein, under a condition no undesired protrusions of said color photo-resist layer around the black matrix are created.
